(19) United States
(12) Patent Application Publication
(10) Pub. No.: US 2010/0133465 A1
(43) Pub. Date: Jun. 3, 2010

(54) DISPERSANT CONTAINING METAL COMPLEX FOR CARBON NANOTUBE

(76) Inventors: Won Jong Kwon, Daejeon (KR); Sunmi Jin, Daejeon (KR); Sungho Yoon, Daejeon (KR); Longhai Piao, Daejeon (KR); Young-Kyu Han, Daejeon (KR); Jaehoon Jung, Daejeon (KR); Jong Chan Kim, Daejeon (KR)

Correspondence Address: MCKENNA LONG & ALDRIDGE LLP, 1900 K STREET, NW, WASHINGTON, DC, 20006, US

(21) Appl. No.: 12/451,352

(22) PCT Filed: May 30, 2008
(86) PCT No.: PCT/KR2008/003052

§ 371 Date: Nov. 9, 2009

(30) Foreign Application Priority Data
May 30, 2007 (KR) 10-2007-0052909

(51) Int. Cl. C09K 5/00; C07F 15/00

(52) U.S. Cl. 252/74; 556/139; 977/742; 977/750; 977/752

(57) ABSTRACT

Disclosed is a composite formed by physical and chemical bonding of (a) a carbon nanotube (CNT); and (b) a metal complex with at least one kind of ligand coordinated to a central metal, the CNT being connected to the metal within the metal complex by a direct bond to the metal. Also, provided is a dispersant for a CNT containing a metal complex comprising (i) a complex ion with at least one kind of ligand (Ln) chemically bonded to a central metal; and (ii) a counter ion. By using a metal complex as a dispersant for a CNT, various characteristics possessed by the metal complex can be provided to the CNT, and the dispersibility of the CNT can be meaningfully increased by introducing a ligand and/or a counter ion having dispersion medium-affinitive properties.

### TECHNICAL FIELD

The present invention relates to a dispersant that provides a carbon nanotube (CNT) with a new functionality derived from a metal complex and can meaningfully increase the dispersibility of the CNT.

### BACKGROUND ART

A carbon nanotube (CNT) has attracted a lot of attention because of its unique properties, such as superior electrical/thermal conductivity and high mechanical strength, since was discovered in 1991 by Dr. Iijima at NEC, Japan. However, its commercialization has not been reached yet due to the difficulty in refinement and dispersion.

A method of dispersing a CNT bundle may be largely classified into a mechanical method, a method in which a dispersant is attached to a CNT via a covalent bond, a method in which a dispersant is attached to a CNT by intermolecular attraction corresponding to a noncovalent bond, and the like. Firstly, the mechanical method includes ultrasonic treatment, ball-milling, etc., but has a disadvantage in that its dispersion effect is merely temporary and does not last for a long time. Secondly, the method of dispersing a CNT via a covalent bond has an advantage of superior and lasting dispersibility, but is disadvantageous in that the unique properties of the CNT deterioate, for example, the π-electron network of the CNT is destroyed, resistance increases, and so forth (KR2006-00313375). Thirdly, the method using a dispersant that is bonded to a CNT in a noncovalent manner by intermolecular attraction is simple and allows the CNT to retain its unique properties, by reason of which research on this method has been actively investigated. Typical examples of this method include a method of wrapping a polymer on a CNT surface, a method using a unimolecular type surfactant, such as SDS or octadecyl amine, a method using a nucleic acid polymer, such as DNA, and a method in which a dispersant in the form of a rigid linear oligomer is attached to a CNT surface in a non-wrapping manner to give dispersibility to the CNT.

The non-covalent type dispersant is characterized in that its dispersing ability is proportional to bonding strength to CNT. When bonding strength is low, the dispersant must be used in large quantities, which may limit the application of a CNT. Zyvex's NanoSolve®, which is excellent in bonding strength to a CNT, provides good dispersibility, but is difficult to synthesize and is expensive. Therefore, there is a need to develop a dispersant that is easy to synthesize and is inexpensive while strongly bound to a CNT.

### DISCLOSURE OF THE INVENTION

A metal complex has very unique electrical, optical, magnetic, and catalytic characteristics, is diverse in kind, and is widely used in various chemical reactions, electronic instruments, optical instruments, sensors, and the like. The metal complex is also used as an additive for imparting various properties to a polymer. A CNT-metal complex composite incorporating the characteristics of such a metal complex with the strength and electrical properties of a CNT is expected to be a new functional material, and thus research thereon is being vigorously performed. However, since a CNT-metal complex composite is not dispersed well, the research is unexceptionally focused on a solid phase, such as an electrode, and there is no precedent where a CNT-metal complex composite has been prepared in a uniformly dispersed form in a dispersion phase.

Therefore, the present invention has been made in view of the above-mentioned problems. The present inventors have discovered that, when a metal complex comprised of a complex ion with at least one kind of ligand coordinated to a metal and a counter ion is used as a dispersant for a CNT, not only the CNT and the metal are strongly bonded to each other via partial charge transfer and π-π stacking, but also the ligand and/or the counter ion can be adjusted in such a manner as to have high affinity to a dispersion medium, which results in a meaningful increase in the dispersibility of the CNT. Also, it is easily synthesized and has a lower price, thereby improving an economical efficiency.

The present invention has been made based on such discovery.

In accordance with an aspect of the present invention, there is provided a composite formed by physical and chemical bonding of (a) a carbon nanotube (CNT); and (b) a metal complex with at least one kind of ligand coordinated to a central metal, the CNT being connected to the metal within the metal complex by a direct bond to the metal.

With regard to this, the ligand may conduct a weak π-π stacking interaction with the CNT while being bonded to a metal ion, or may exist without being directly bonded to the CNT.

In accordance with another aspect of the present invention, there is provided a dispersant for a CNT, containing a metal complex comprised of (i) a complex ion with at least one kind of ligand (Lₙ) chemically bonded to a central metal in a range of 1≦n≦8; and (ii) a counter ion satisfying a charge neutrality condition of the complex ion.

In accordance with yet another aspect of the present invention, there is provided a composition for a CNT, comprising the above dispersant.

In accordance with still yet another aspect of the present invention, there is provided an electrochemical device manufactured using the above composition for a CNT.

Hereinafter, the present invention will be described in more detail.

A carbon nanotube (hereinafter referred to as “CNT”) not only has better mechanical properties than those of a common high-strength alloy because it has high tensile strength and superior elasticity, but also possesses electrical characteristics, such as current transport ability and heat transfer. In comparison to the above advantages, the CNT has strong cohesion because of its large surface area and low density. Such strong cohesion of the CNT hinders uniform CNT dispersion, and thus makes it impossible for the CNT to exhibit its unique characteristics. Therefore, in order to prevent this problem, a dispersant must be added.

In order to uniformly disperse a CNT bundle in a dispersion medium or medium, a dispersant must generally possess a moiety (\textcircled{1}) that is bonded to a CNT, and simultaneously must possess a solvent-affinitive moiety (\textcircled{2}) that is mixed well with the dispersion medium. However, most conventional CNT dispersants are polymer-based dispersants, in particular, hydrocarbon-based dispersants, each of which is bonded to a CNT mainly via π-π stacking, and thus there is a problem in that a CNT bundle cannot be sufficiently dispersed due to the low solubility and high viscosity of the polymer. Moreover, since a conventional polymer-based dispersant is bonded to a CNT by a π-π stacking interaction, not only the polymer to be used is limited to a polymer structurally including an unsaturated bond, but also there is a problem with the π-π stacking interaction that is relatively weak.

Thereupon, the present invention is characterized in that, instead of a polymer-based dispersant that causes the above-mentioned problems, a metal complex is used as a dispersant for a CNT.

The metal complex of the present invention may be comprised of a complex ion with at least one kind of ligand coordinated to a central metal, and a counter ion satisfying a charge neutrality condition. With regard to this, the metal may form a coordination bond to a CNT through an empty or full d-orbital.

Also, when the CNT and the central metal are bonded to each other, the metal complex ion with relatively insufficient electrons acts as an electron-acceptor, and the CNT with relatively sufficient electrons acts as an electron-donor, so that partial charge transfer can occur between them. Such charge transfer (CT) forms a stronger bond than the above-mentioned π-π stacking bond, and thus the problem caused by the weak bonding strength of a conventional polymer-based dispersant can be essentially solved.

In the CNT-metal complex composite of the present invention, the CNT and the metal complex are actually bonded via a π-π stacking bond and CT, and such partial CT has been computationally proven to have higher binding energy than the conventional π-electron network stacking bond (see FIG. 8).

A material used as the CNT dispersant of the present invention may be any metal complex known in the art, more particularly a metal complex comprising a complex ion with at least one kind of ligand coordinated to a central metal and a counter ion.

The metal complex may be expressed by the following Formula 1, but is not limited thereto:

MLₓC(I) [Formula 1]

In Formula 1, M is any metal known in the art;

L is a ligand coordinated to the metal, where x is an integer of 1≦n≦8; and

C is a counter ion.

In Formula 1, there is no particular limitation on the metal, so long as it can form a coordination bond to the ligand (Lₓ), thereby forming a complex. Non-limiting examples of the metal include Fe^{l+}, Ni^{l+}, Zn²⁺, Cu^{m+}, Mnⁿ⁺, Al³⁺, Tiⁿ⁺, Crⁿ⁺, Vⁿ⁺, Moⁿ⁺, Ru^{l+}, Rhⁿ⁺, Pdⁿ⁺, Ag⁺, Cdⁿ⁺, Reⁿ⁺, Osⁿ⁺, Irⁿ⁺, Ptⁿ⁺, Auⁿ⁺, Snⁿ⁺, Pbⁿ⁺, Wⁿ⁺, any combination thereof, etc. Here, l, m, and n are each an integer of 2≦1≦3, 1≦m≦2, and 1≦n≦7.

There is no particular limitation on the ligand (L), so long as it can form a coordination bond to the metal (M). Non-limiting examples of the ligand include phenanthroline or phenantheroline derivatives; salicylic acids or salicylate derivatives; hydroxyquinoline or hydroxyquinoline derivatives; 2,2′-dipyridyl or 2,2′-dipyridyl derivatives; catechol or catechol derivatives; ethylene diamine tetraacetic acids (EDTA) or ethylene diamine tetraacetic acid derivatives; amino acids or amino acid derivatives; alkyl amines of chain length 1˜24 (C₁˜C₂₄); polyamines, such as polyethyleneimine; alkyl carboxylic acids of chain length 1˜24 (C₁˜C₂₄); any combination thereof; etc. Here, the ligands coordinated to the metal may be of the same kind or of different kinds, and may include at least one kind of ligand.

Non-limiting examples of the complex ion formed by bonding of the metal (M) to the ligand (L) include [Fe(phenanthroline)₃]^{p+}, [Fe(salicylate)₃]^{q-}, [Fe(hydroxyquinoline)₃]^{q-}, [Fe(2,2′-dipyridyl)₃]^{p+}, [Fe(catechol)₃]^{q-}, [Fe(EDTA)]^{q-}, [Fe(glycine)₃]^{q-}, [Co(phenanthroline)₃]^{p+}, [Co(phenanthroline)₃]^{p+}, [Co(salicylate)₃]^{q-}, [Co(hydroxyquinoline)₃]^{q-}, [Co(2,2′-dipyridyl)₃]^{p+}, [Co(catechol)₃]^{q-}, [Co(EDTA)]^{q-}, [Co(glycine)₃]^{q-}, [Cu(phenanthroline)₃]^{p+},

[Cu(salicylate)₃]^{q-}, [Cu(hydroxyquinoline)₃]^{q-}, [Cu(2,2′-dipyridyl)₃]^{p+}, [Cu(catechol)₃]^{q-}, [Cu(EDTA)]^{q-}, [Cu(glycine)₃]^{q-}, [Ni(phenanthroline)₂]^{p+}, [Ni(salicylate)₃]^{q-}, [Ni(hydroxyquinoline)₃]^{q-}, [Ni(2,2′-dipyridyl)₃]^{p+}, [Ni(catechol)₃]^{q-}, [Ni(EDTA)]^{q-}, [Ni(glycine)₃]^{q-}, [Ru(phenanthroline)₃]^{p+}, [Ru(salicylate)₃]^{q-}, [Ru(hydroxyquinoline)₃]^{q-}, [Ru(2,2′-dipyridyl)₃]^{p+}, [Ru(catechol)₃]^{q-}, [Ru(EDTA)]^{q-}, [Ru(glycine)₃]^{p+}, [Al(hydroxyquinoline)₃]³⁺, etc. Here, p and q are each an integer of 0≦p≦3 and 0≦q≦5.

A material satisfying the charge neutrality of the metal complex ion may be used as the counter ion bonded to the metal complex ion. Non-limiting examples of the counter ion that may be used in the, present invention include alkyl sulfonic acids (C₁˜C₂₄) or aryl sulfonic acid derivatives; high molecular weight sulfonic acids, such as polystyrene sulfonate; tetraalkyl ammonium ions including alkyl groups of chain length 1˜24 (C₁˜C₂₄); imidazolium ions including alkyl groups of chain length 1˜24 (C₁˜C₂₄); fluorine-based anions, such as BF₄⁻, PF₆⁻, (CF₃SO₂)₂N⁻; etc. In addition, ions satisfying the charge neutrality condition of the metal complex ion also fall within the equivalent scope of the present invention.

In the metal complex of the present invention, either or both of the ligand (L) and the counter ion (C), except the central metal, exist without being directly bonded to the CNT, or conduct a weak π-π stacking interaction with the CNT while being bonded to the central metal (M). With regard to this, if either or both of the ligand (L) and the counter ion (C) are adjusted in such a manner as to have the same types of properties as those of a solvent or dispersion medium to be used, which are affinitive to the solvent or dispersion medium, then it is possible to meaningfully increase the dispersibility of the CNT.

Preferably, either or both of the ligand and the counter ion of the metal complex include at least one kind of polar or non-polar moiety that is of the same type as polarity or non-polarity possessed by a dispersion medium to be used. Here, the polar or non-polar moiety means any polar or non-polar group known in the art, and there in no particular limitation on the polar or non-polar moiety. For example, the non-polar moiety means a moiety consisting of hydrocarbons, and the polar moiety includes a hydroxyl group, a carboxy group, etc.

The metal complex of the present invention, which has the above-mentioned structure, can be added to and mixed with a dispersion, in which a CNT bundle are dispersed, to thereby provide the CNT with superior dispersibility. With regard to this, the usage ratio of the metal complex to the CNT may be appropriately adjusted in consideration of a change in the characteristics of the CNT and the degree of dispersibility. As an example, the metal complex may be used in an amount of 0.01 to 2000 parts by weight, based on 100 parts by weight of the CNT.

When the metal complex is introduced into the CNT-dispersed solution in this way, physical and/or chemical bonds are formed between the CNT and the metal complex, which results in the formation of a novel composite compound.

Such a novel composite compound is different in structure and properties from a conventional composite compound with a metal complex connected to a CNT, more particularly a conventional composite compound obtained by using a CNT, which is artificially provided on a part of its surface with a polar group, and forming a covalent bond between the polar group of the CNT and a ligand of a metal complex.

That is, only when a CNT dispersant is strongly bonded to a CNT on one side, and has the same type of moiety as that of a dispersion medium on the other side, it can increase the dispersibility of the CNT. However, in the, conventional composite compound, a component bonded to a CNT is not a metal, but a ligand (L). Since such a ligand (L) only acts as a moiety that is bonded to the CNT, and cannot act as a solvent-affinitive moiety, it is difficult to even attempt to improve the dispersibility of the CNT, even when a ligand with a polar or non-polar moiety introduced therein is used. Also, the conventional composite compound additionally requires an oxidation process in which an oxygen moiety for a covalent bond to the ligand within the metal coordination complex is artificially formed on the outer surface of the CNT.

Contrarily, the novel composite compound of the present invention has a structural feature that the CNT is connected to the metal of the metal complex via a direct bond to the metal, and the ligand is not bonded to the CNT or is weakly bonded to the CNT via π-π stacking while being coordinated to the metal (see FIG. 1).

With regard to this, since the ligand and/or the counter ion are not bonded to the CNT or exist in the state of being weakly bonded to the CNT, dispersibility can be freely adjusted by including at least kind of polar or non-polar moiety, which is of the same type as that of a dispersion medium and is mixed well with the dispersion medium, in the ligand and/or the counter ion.

Also, the metal complex of the present invention is comprised of a metal that is bonded to a CNT, a ligand having the same types of properties as those of a dispersion medium, a counter ion, etc. as constituent elements, but does not destroy the π-electron network of the CNT because all the constituent elements do not form a covalent bond to the CNT. On account of this, the CNT can exhibit its unique properties in their entirety without any deformation.

Furthermore, in the present invention, no additional process is required in the formation of the composite compound, and the CNT is charged with a positive charge by the metal complex-CNT bond. Thus, a CNT bundle can be easily debundled by electrostatic repulsion between the metal complex and the CNT.

As a result of this, the novel composite compound of the present invention can form a strong bond to the CNT via π-π stacking between the CNT and the metal of the metal complex and partial charge transfer, thereby promoting physical stability. Also, since a CNT bundle can be easily debundled by the composite compound charged in a specific charge state, and simultaneously the composite compound uses a ligand and/or a counter ion with the same type of polar or non-polar moiety introduced therein, the composite compound can more meaningfully increase the dispersibility of the CNT (see FIG. 3).

Any CNT known in the art may be used as a CNT capable of forming a composite compound with the above-mentioned metal complex, without any particular limitation. Non-limiting examples of the CNT include a single-walled carbon nanotube (SWNT), a double-walled carbon nanotube (DWNT), a multi-walled carbon nanotube (MWNT), a bundle-type carbon nanotube, or a mixture thereof.

When a metal complex is introduced as a dispersant into a CNT-dispersed solution, as mentioned above, the metal complex may be removed by acid addition. Here, any acid selected from common acids known in the art may be used in the acid addition, and there is no particular limitation on its composition and usage.

The present invention provides a CNT composition comprising a dispersant containing the above-mentioned metal complex, a CNT, and a dispersion medium.

With regard to this, there is no particular limitation on the composition ratio of the CNT composition. As an example, the CNT composition may comprise 0.001 to 30 parts by weight of CNT, 0.001 to 50 parts by weight of dispersant, and the balance of dispersion medium, based on the total 100 parts by weight of the CNT composition. For example, the dispersion medium may be used as a range from 20 to 99.99 parts by weight based on the total 100 parts by weight of the CNT composition.

Any solvent and/or dispersion medium known in the art may be used as the dispersion medium, and non-limiting examples thereof include water; alcohols, such as enthanol, isopropyl alcohol, propyl alcohol, and butanol; ketones, such as acetone, methyl ethyl ketone, and ethyl isobutyl ketone; glycols, such as ethylene glycol, ethylene glycol methyl ether, ethylene glycol mono-n-propyl ether propylene glycol, propylene glycol methyl ether, propylene glycol ethyl ether, and propylene glycol butyl ether; amides, such as dimethylformamide and dimethylacetoamide; pyrrolidones, such as N-methylpyrrolidone and N-ethylpyrrolidone; hydroxyl esters, such as dimethyl sufoxide; anilines, such as aniline and N-methylaniline; hexane; terpineol; chloroform; toluene; N-methyl-2pyrrolidone (NMP); etc.

The CNT composition may further comprises a binder, organic additives, or other conventional additives.

The CNT composition of the present invention can favorably disperse a CNT bundle in a dispersion medium without impairing the properties of the CNT itself, and can exhibit superior dispersion stability because there is no agglomeration or separation.

In particular, the present invention makes it possible to adjust the dispersibility of a CNT by adjusting the properties of the ligand and/or the counter ion included in the metal complex when the CNT dispersant containing the metal complex is used.

The ligand and/or the counter ion may be one containing the same type of polar or non-polar moiety as that of a dispersion medium. For example, when a CNT dispersion medium is a polar solvent, the dispersibility of a CNT may be increased by using a ligand and/or a counter ion containing at least one common polar group. Contrarily, when a dispersion medium is a non-polar solvent, the dispersibility of a CNT may be freely adjusted by using a ligand and/or a counter ion containing a non-polar group, such as hydrocarbons.

A method of adjusting the dispersibility of a CNT according to the present invention may be implemented in the following two ways, but the present invention is not limited thereto:

Firstly, a CNT bundle, a dispersion medium, and a metal complex salt are mixed, with the proviso that a metal complex containing a ligand and/or a counter ion with the same type of polar or non-polar moiety as that of the dispersion medium is used as the metal complex.

Secondly, a CNT bundle, a dispersion medium, and a metal complex are mixed, and then another dispersive counter ion salt with the same type of polar or non-polar moiety as that of the dispersion medium is added to and mixed with the mixture.

A part of the counter ion of the added salt is exchanged with a counter ion within the CNT-metal complex composite to form a CNT-metal complex-solvent-affinitive counter ion composite, and the dispersibility of the CNT can be increased through the formation of such a composite (see Example 2). With regard to this, the above effect may be better when the metal complex contains a ligand with the same type of polar or non-polar moiety as that of the dispersion medium.

Also, the CNT may be selectively provided with functionality derived from the metal complex, such as catalytic and optical properties, according to the kind of the metal complex bound to the CNT.

The above-mentioned second way to implement the method of adjusting the dispersibility of a CNT is preferable because it can solve a limitation of selectively using only a metal complex containing the same type of polar (non-polar) moiety as that of a dispersion medium and the high cost of such a metal complex at the same time.

The above CNT composition may from an electrically conductive film through a common coating method, such as spin coating, electrophoretic deposition, ink-jet printing, casting, spray, and offset printing.

Also, the present invention provides an electrochemical device manufactured using the above CNT composition.

There is no particular limitation on the electrochemical device, so long as it is a device requiring the superior electrical conductivity of a CNT, and non-limiting examples thereof include all kinds of primary and secondary batteries, a fuel cell, a solar cell, a capacitor, an electron gun or electrode of a field emission display (FED), an electroluminescent display, a transparent electrode, such as a liquid crystal display, a luminescent material constituting an organic electroluminescent device, a buffer material, an electron transport material, a hole transport material, etc.

In the present invention, a wiring capable of being applied to various electrochemical devices was actually formed using a conductive paste comprising the CNT-metal complex-counter ion composite of the present invention, and it was confirmed that such a wiring exhibits superior conductivity (see FIG. 9).

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a conceptual view schematically illustrating a CNT-metal complex-counter ion composite of the present invention;

FIG. 2 is a view briefly illustrating a process of preparing a CNT-metal complex-counter ion dispersed solution;

FIG. 3 is a view schematically illustrating a process of dispersing a CNT-metal complex-counter ion composite;

FIG. 4 is a graph illustrating UV-Vis spectra before and after the formation of a CNT-ferroin composite aqueous dispersion, as a function of concentration of ferroin complex;

FIG. 5 is a photographic view illustrating the state of each of a CNT-ferroin composite solution, a supernatant thereof, and a washed solution thereof;

FIG. 6 is a graph illustrating a change in the amount of ferroin bound to a CNT (200 mg), as a function of concentration of ferroin;

FIG. 7 is a photographic view illustrating an aqueous dispersion in which a CNT-ferroin composite containing a PSS-Na counter ion dispersant is dispersed;

FIG. 8 is a virtual view of a CNT-ferroin complex system, the binding energies of which are obtained using a quantum chemical software package; and

FIG. 9 is as photographic view of a conductive wiring printed with conductive paste made of a CNT-metal complex-counter ion composite.

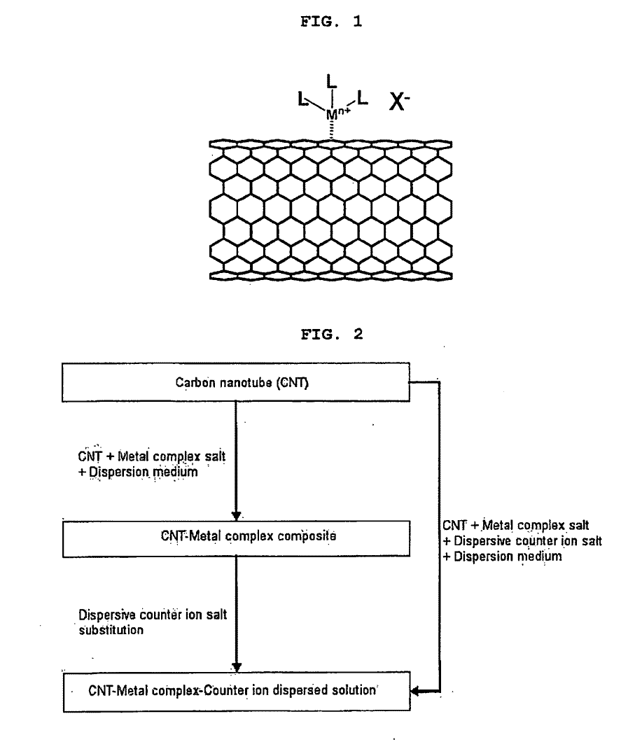

### BEST MODE FOR CARRYING OUT THE INVENTION

Reference will now be made in detail to the preferred embodiments of the present invention. It is to be understood that the following examples are illustrative only, and the scope of the present invention is not limited thereto.

### Example 1

1-1. Preparation for CNT

CNT was prepared by the following method that 90 vol % of SWNT (Iljin Nanotech) with a diameter of 1 to 2 nm and a length of 5 to 20 μm was refluxed in 15 M of concentrated nitric acid for one hour, was filtered, was washed several times with distilled water until the pH reached neutrality, and then was freeze-dried.

1-2. Formation of CNT-Metal Complex Composite

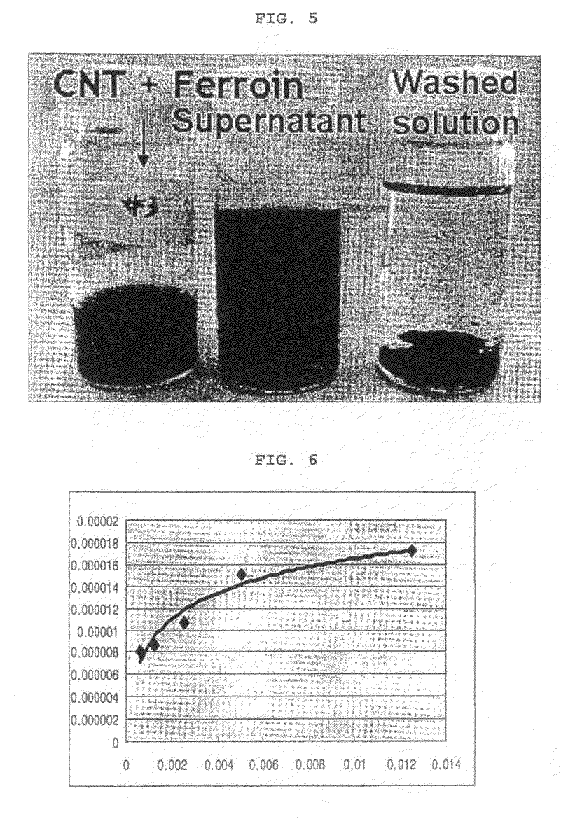

Ferroin ([Fe(phenanthroline)₃]SO₄) aqueous solutions of various concentrations were prepared in an amount of 10 ml respectively. 200 mg of the SWNT prepared in Example 1-1 was mixed with each solution followed by ultrasonic treatment for 30 minutes to form a composite ([Fe(Phenanthroline)₃]SO₄ (ferroin)-SWNT). Subsequently, each mixture solution was separated into a solid and a supernatant through centrifugation (see FIG. 5).

1-3. Formation of Conductive Paste

0.2 g of the ferroin-SWNT composite prepared in Example 1-2, 0.6 g of ethylcellulose (Aldrich), and 3 g of butylcarbitol were mixed, and then conductive paste was prepared from the mixture by using a 3-roll mill.

1-4. Formation of Conductive Wiring Circuit

A conductive wiring circuit was fabricated by screen-printing the conductive ferroin-SWNT composite paste prepared in Example 1-3. The fabricated conductive wiring circuit showed a conductivity of 300 ohm/sq (see FIG. 9).

### Example 2

200 mg of the CNT-ferroin composite obtained in Example 1 was mixed with 10 ml of polystyrene sulfonate-Na (PSS-Na) 10% aqueous solution, and then the mixture was subjected to ultrasonic treatment for 30 minutes to form a composite ([Fe(Phenanthroline)₃]SO₄-SWNT-PSSNa). It could be confirmed that the so-prepared CNT-ferroin-PSS composite was dispersed well in an aqueous solution (see FIG. 7).

### Example 3

3-1. Formation of CNT-Metal Complex Composite

An MWNT-ferroin composite was formed in the same manner as in Example 1, except that an MWNT (Nanocyl) with an average diameter of 5 to 10 nm and a length of 5 to 20 μm was used in place of the SWNT of Example 1.

3-2. Formation of Conductive Paste

Conductive paste was prepared in the same manner as in Example 1-3, except that 0.2 g of the ferroin-MWNT composite prepared in Example 3-1 was used.

3-3. Formation of Conductive Wiring Circuit

A conductive wiring circuit was fabricated by screen-printing the conductive ferroin-MWNT composite paste prepared in Example 3-2. The fabricated conductive wiring circuit showed a conductivity of 500 ohm/sq.

### Example 4

20 mg of the CNT-ferroin composite obtained in Example 3 was mixed with 10 ml of polystyrene sulfonate-Na (PSS-Na) 10% aqueous solution, and then the mixture was subjected to ultrasonic treatment for 30 minutes to form a composite ([Fe(Phenanthroline)₃]SO₄-MWNT-PSSNa).

### Example 5

5 g of CuCl₅ was mixed with 10 ml of polyethyleneimine (PEI, Aldrich; number average molecular weight: 60,000) 10 wt % aqueous solution to obtain a polyethyleneimine-Cu(PEI-Cu) complex aqueous solution.

200 mg of the SWNT of Example 1-1 was mixed with 100 ml of the obtained PEI-Cu complex aqueous solution, and then the mixture was subjected to ultrasonic treatment for 30 minutes to form a composite (PEI-Cu-SWNT).

### Example 6

A composite (PEI-Zn-SWNT) was formed in the same manner as in Example 5, except that Zn(OAc)₂ was used as a metal salt.

### Example 7

A composite (PEI-Cu-MWNT) was formed in the same manner as in Example 5, except that the MWNT of Example 3 was used in place of the SWNT of Example 1.

### Example 8

A composite (PEI-Zn-MWNT) was formed in the same manner as in Example 7, except that Zn(OAc)₂ was used as a metal salt.

### Comparative Example 1

A SWNT-dispersed solution was prepared in the same manner as in Example 1, except that a metal complex was not used, but the CNT (SWNT) of Example 1-1 and a PSS-Na aqueous solution were used. In the dispersed solution prepared in this way, it could be confirmed that the CNT was partially dispersed, but the dispersion is significantly inferior compared to the dispersed solutions of Example 2 and Examples 4 to 8 because of the precipitation.

### Experimental Example 1

### Binding Energy Simulation of CNT-Metal Complex Composite

The CNT-metal complex composite according to the present invention was proven by a computational (or quantum chemical) approach.

In order to calculate binding energy between a CNT and a metal complex (e.g. ferroin), electronic structure calculation was performed using the PW92 local density approximation method [J. P. Perdew and Y. Wang, Phys. Rev. B, 45, 13244 (1992)] that is one of Density Functional Theory (DFT) functional. Here, a double numerical plus d-functions (DNP) basis set was used in the calculations. The COSMO (COnductor-like Screening MOdel) method [A. Klamt and G. Schüürmann, J. Chem. Soc., Perkin Trans. 2, 799 (1993)] was used to describe a solvent effect, and the amount of charge was measured by the Hirshfeld analysis method [F. L. Hirshfeld, Theor. Chim. Acta, 44, 129 (1977)]. All calculations were carried out using a commercial DFT program called DMol3 [B. Delley, J. Chem. Phys., 92, 508 (1990); B. Delley, J. Chem. Phys., 113, 7756 (2000)].

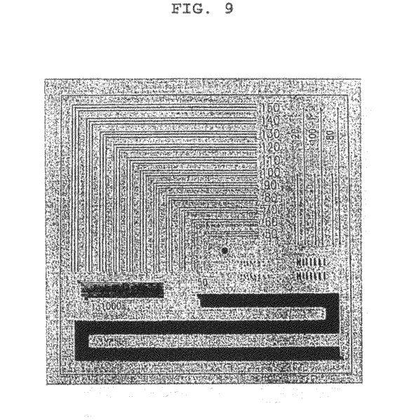

A (6,6) armchair single-walled nanotube (SWNT) was used for CNT modeling, and terminal carbons of the (6,6) armchair SWNT were stabilized by binding hydrogen thereto. All structures before and after the binding were optimized, and the most stable SWNT-ferroin structure is illustrated in FIG. 8. Based on the ionized state of ferroin (A), the binding energy (0.7 eV) when ferroin forms a complex with a CNT is very large. (D). The binding energy is larger than binding energy (0.1 eV) of ferroin with SO₄²⁻ forming a salt (B). A reaction where a ligand of ferroin is decomposed is very unstable, and thus is not expected to occur (C). Therefore, ferroin ionized in an aqueous solution phase is determined to be able to form a stable complex with a CNT without ligand decomposition.

The structure of the most stable complex (D) is a structure in which two phenanthroline molecules corresponding to two ferroin ligands are located at a distance of about 3.1 Å from a CNT, and it has been confirmed that there is an interaction between the π-orbital of a ligand and the π-orbital of a CNT in the structure, as shown in the plotted HOMO (highest occupied molecular orbital) of the complex (E). With regard to this, the amount of charge transfer from a CNT to ferroin is calculated as a value of 0.5 e (see FIG. 8). This means that a covalent bond exists between a CNT and a metal ion. It can be inferred that a CNT-metal complex bond of the CNT-metal complex composite of the present invention has higher binding energy through partial charge transfer (CT).

### Experimental Example 2

### Quantification of Composite

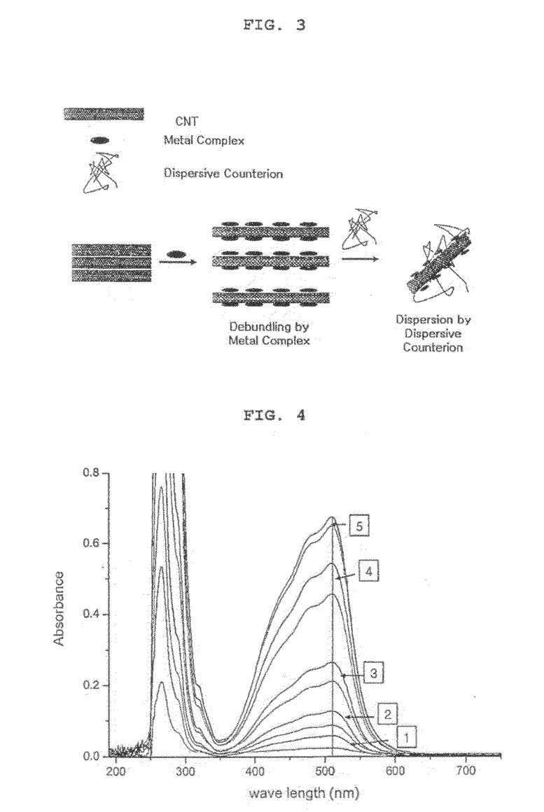

A UV-Vis spectrum was measured for each of the supernatant and the aqueous solution before mixing of the SWNT in Example 1, and the amount of ferroin was quantified from absorbance at a wavelength of 510 nm. Also, based on this, the amount of ferroin bound to the SWNT surface was obtained (see FIG. 4). Here, the fifth experiment was out of the effective measurement range of UV-Vis absorbance, and thus absorbance was measured after the supernatant and the aqueous solution were diluted by ½. Thus, absorbance plotted by curve 5 in FIG. 4 corresponds to a doubled value into which the measurement value is reconverted.

In addition, Table 1 shows absorbance data that were measured at a wavelength of 510 nm before and after a reaction between a CNT and ferroin so as to quantify a change in the amount (mol) of ferroin bound to the CNT (200 mg) according to a change in the concentration of ferroin.

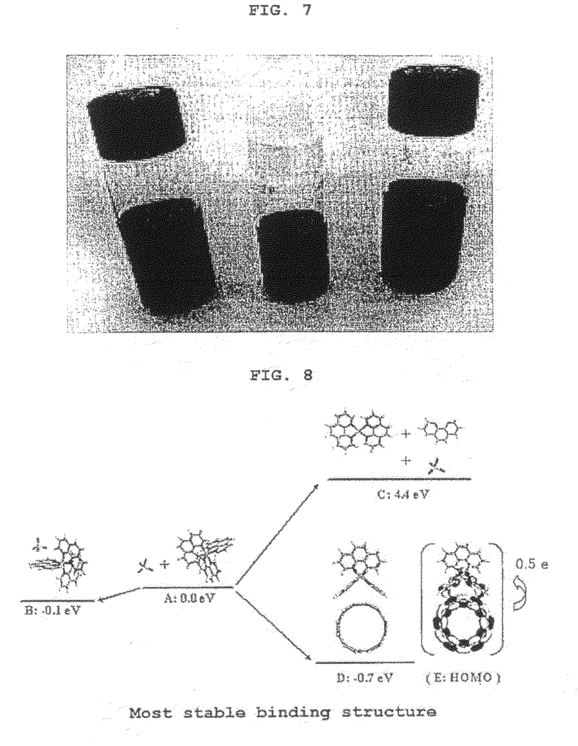

As a result of experiments, it could be noted that the amount of ferroin bound to the SWNT surface was gradually saturated as the amount of ferroin increased (see FIG. 6 and Table 1).

Also, although the CNT-metal complex composite obtained after the centrifugation was washed several times with an aqueous solution, ferroin did not exist in the washed solution. From this, it could be confirmed that ferroin was very strongly bound to the SWNT surface (see FIG. 5).

TABLE 1

| | | | | mol of |
|---|---|---|---|---|
| | | | absorbance | ferroin |
| | total | absorbance | after | bound to |
| | concentration | before bound | bound to | 200 mg of |
| | of ferroin | to CNT | CNT | CNT |
| | (mM) | (510 nm) | (510 nm) | (μmol) |
| 1 | 0.625 | 0.058 | 0.024 | 8.05 |
| 2 | 1.25 | 0.128 | 0.088 | 8.69 |
| 3 | 2.5 | 0.265 | 0.212 | 10.7 |
| 4 | 5.0 | 0.544 | 0.458 | 15.1 |
| 5 | 12.5 | *1.350 | *1.302 | 17.3 |

### INDUSTRIAL APPLICABILITY

As can be seen from the foregoing, the present invention provides a metal complex-containing dispersant for a CNT. The metal complex is strongly bound to the CNT via partial charge transfer and π-π stacking, and thus can increase the polarity of a CNT surface, which makes it possible for a CNT bundle to be dispersed well in a solution. Also, the dispersibility of the CNT can be very easily adjusted by deforming and substituting a ligand and a counter ion within the metal complex.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A composite formed by physical and chemical bonding of:
(a) a carbon nanotube (CNT); and
(b) a metal complex with at least one kind of ligand coordinated to a central metal,
wherein the CNT is connected to the metal within the metal complex by a direct bond to the metal.

2. The composite as claimed in claim 1, wherein the ligand conducts a π-π stacking interaction with the CNT while being bonded to the central metal, or exists without being directly bonded to the CNT.

3. The composite as claimed in claim 1, wherein the metal complex is bonded to the CNT via partial charge transfer and π-π stacking.

4. The composite as claimed in claim 1, wherein the metal complex comprises:
(i) a complex ion with at least one kind of ligand (Lₙ) chemically bonded to the central metal in a range of 1≦n≦8; and
(ii) a counter ion satisfying a charge neutrality condition of the complex ion.

5. The composite as claimed in claim 1, wherein the metal constituting the metal complex is selected from the group consisting of Fe¹⁺, Ni^{l+}, Zn²⁺, Cu^{m+}, Mnⁿ⁺, Al³⁺, Tiⁿ⁺, Crⁿ⁺, Vⁿ⁺, Moⁿ⁺, Ru^{l+}, Rhⁿ⁺, Pdⁿ⁺, Ag⁺, Cdⁿ⁺, Reⁿ⁺, Osⁿ⁺, Irⁿ⁺, Ptⁿ⁺, Auⁿ⁺, Snⁿ⁺, Pbⁿ⁺, and Wⁿ⁺ (where l, m, and n are each an integer of 2≦l≦3, 1≦m≦2, and 1≦n≦7).

6. The composite as claimed in claim 1, wherein the ligand is at least one kind selected from the group consisting of phenanthroline, salicylic acid, hydroxyquinoline, 2,2′-dipyridyl, catechol, ethylene diamine tetraacetic acid (EDTA), amino acid, polyamine, a C₁˜C₂₄ alkyl amine, and a C₁˜C₂₄ alkyl carboxylic acid.

7. The composite as claimed in claim 4, wherein the counter ion is selected from the group consisting of C₁˜C₂₄ alkyl sulfonic acid, aryl sulfonic acid derivatives, polystyrene sulfonate, a tetraalkyl ammonium ion containing a C₁˜C₂₄ alkyl group, an imidazolium ion containing a C₁˜C₂₄ alkyl group, BF₄⁻, PF₆⁻, and (CF₃SO₂)₂N⁻.

8. The composite as claimed in claim 1, wherein the CNT is selected from the group consisting of a single-walled carbon nanotube (SWNT), a double-walled carbon nanotube (DWNT), a multi-walled carbon nanotube (MWNT), and a bundle-type carbon nanotube.

9. A dispersant for a carbon nanotube (CNT) containing a metal complex comprising:
(i) a complex ion with at least one kind of ligand (Lₙ) chemically bonded to a central metal in a range of 1≦n≦8; and
(ii) a counter ion satisfying a charge neutrality condition of the complex ion.

10. The dispersant as claimed in claim 9, wherein either or both of the ligand and the counter ion contain a polar or non-polar moiety that is of the same type as polarity or non-polarity possessed by a dispersion medium for dispersing the CNT.

11. The dispersant as claimed in claim 9, wherein the metal complex is physically and chemically bonded to the CNT to thereby charge the CNT with a positive charge.

12. The dispersant as claimed in claim 9, wherein the metal complex is used in an amount of 0.01 to 2000 parts by weight, based on 100 parts by weight of the CNT.

13. A carbon nanotube (CNT) composition comprising: (a) the dispersant containing a metal complex comprised of a complex ion with at least one kind of ligand chemically bonded to a central metal, and a counter ion, as claimed in claim 9;
(b) a CNT; and
(c) a dispersion medium.

14. The CNT composition as claimed in claim 13, which comprises 0.001 to 30 parts by weight of the CNT, 0.001 to 50 parts by weight of the dispersant, and 20 to 99.99 parts by weight of the dispersion medium, based on the total 100 parts by weight of the CNT composition.

15. The CNT composition as claimed in claim 13, wherein in order to increase dispersibility of the CNT,
(a) either or both of the ligand and the counter ion contain a polar or non-polar moiety that is of the same type as polarity or non-polarity possessed by the dispersion medium, or
(b) another counter ion salt with the same type of polar or non-polar moiety as polarity or non-polarity possessed by the dispersion medium is further added to and mixed with the CNT composition.

16. The CNT composition as claimed in claim 15, wherein the ligand containing a polar or non-polar moiety that is of the same type as polarity or non-polarity possessed by the dispersion medium is used at the same time with the counter ion salt with the same type of polar or non-polar moiety as polarity or non-polarity possessed by the dispersion medium.

17. An electrochemical device manufactured using the carbon nanotube (CNT) composition as claimed in claim 13, which includes at least one kind selected from the group consisting of an electrode, an electrically conductive film, a luminescent material, a buffer material, an electron transport material, and a hole transport material.

18. The CNT composition as claimed in claim 13, wherein either or both of the ligand and the counter ion contain a polar or non-polar moiety that is of the same type as polarity or non-polarity possessed by a dispersion medium for dispersing the CNT.

19. The CNT composition as claimed in claim 13, wherein the metal complex is physically and chemically bonded to the CNT to thereby charge the CNT with a positive charge.

20. The CNT composition as claimed in claim 13, wherein the metal complex is used in an amount of 0.01 to 2000 parts by weight, based on 100 parts by weight of the CNT.
